(19) United States
(12) Patent Application Publication
(10) Pub. No.: US 2011/0175868 A1
(43) Pub. Date: Jul. 21, 2011

(54) DISPLAY DEVICE, METHOD OF DRIVING THE DISPLAY DEVICE, AND ELECTRONIC UNIT

(75) Inventors: Tetsuo Minami, Tokyo (JP); Katsuhide Uchino, Kanagawa (JP)

(73) Assignee: SONY CORPORATION, Tokyo (JP)

(21) Appl. No.: 12/986,459

(22) Filed: Jan. 7, 2011

(30) Foreign Application Priority Data
Jan. 15, 2010 (JP) 2010-006990

(51) Int. Cl. G09G 5/00

(52) U.S. Cl. 345/205

(57) ABSTRACT

A display device includes a display section including a plurality of scan lines and a plurality of power lines, being arranged in rows, a plurality of signal lines arranged in columns, and a plurality of pixels arranged in a matrix; and a driver section driving each pixel. The power lines are individually provided for each of units with a plurality of pixel rows as a unit, and the driver section reverses a scan direction of scan lines in the unit between odd and even fields.

### BACKGROUND OF THE INVENTION

1. Field of the Invention

The present invention relates to a display device displaying images by using a light emitting element disposed for each pixel, and a method of driving the display device. Furthermore, the invention relates to an electronic unit having the display device.

2. Description of Related Art

Recently, in a field of display devices for image display, a display device using a current-drive optical element as a light emitting element of a pixel, the optical element being changed in luminance in accordance with a value of electric current flowing into the optical element, for example, a display device using organic EL (Electro Luminescence) elements has been developed and is being commercialized. The organic EL element is a self-luminous element unlike a liquid crystal element or the like. Therefore, the display device using organic EL elements (organic EL display device) does not need a light source (backlight), and therefore is high in image visibility, low in power consumption, and high in response speed compared with a liquid crystal display device that needs a light source.

Drive methods of the organic EL display device include simple (passive) matrix drive and active matrix drive as in the liquid crystal display device. The simple matrix drive has an advantage where device structure may be simplified, but has a difficulty where a large display with high definision is hardly achieved. Therefore, the active matrix drive is being actively developed at present. In the active matrix drive, a current flowing into a light emitting element disposed for each pixel is controlled by a driver transistor.

Generally, threshold voltage Vₜₕ or mobility μ of a driver transistor may be temporally varied, or the threshold voltage Vₜₕ or the mobility μ may be different for each of pixels due to variation in a manufacturing process. When the threshold voltage Vₜₕ or the mobility μ is different for each pixel, a value of current flowing into the driver transistor varies for each pixel, and therefore even if the same voltage is applied to gates of driver transistors, luminance of an organic EL element varies for each pixel, leading to reduction in uniformity of a screen. Thus, a display device is developed, which includes a function of correcting variation in threshold voltage Vₜₕ or in mobility μ (for example, see Japanese Unexamined Patent Application Publication No. 2008-083272).

In the active-matrix display device, any of a signal line driver circuit, which drives signal lines, a write line driver circuit, which sequentially selects a pixel, and a power line driver circuit, which supplies power to each pixel, is basically configured of a shift register (not shown), and has a signal output section (not shown) for each stage in correspondence to each pixel column or each pixel row. Therefore, when the number of pixel columns and the number of pixel rows are increased, the number of signal lines and the number of gate lines are accordingly increased, and the number of output stages of a shift register is correspondingly increased, leading to increase in size of a peripheral circuit of a display device.

Thus, a measure of sharing an output stage of a shift register has been taken in the past in order to reduce size of a peripheral circuit. For example, Japanese Unexamined Patent Application Publication No. 2006-251322 proposes a method where a signal line is shared by a plurality of pixels. According to this, each output stage of a shift register in the signal line driver circuit may be shared by a plurality of pixel columns, and a circuit scale, circuit area, and circuit cost may be correspondingly reduced.

### SUMMARY OF THE INVENTION

Japanese Unexamined Patent Application Publication No. 2006-251322 describes that an output stage of a shift register in a signal line driver circuit is shared by a plurality of pixel columns. Even in a write line driver circuit or a power line driver circuit, an output stage of a shift register is importantly shared in order to improve cost performance of a display device. Particularly, in the power line driver circuit, since size of a signal output section needs to be large to stabilize current supply capability, each output stage of a shift register in the power line driver circuit is shared by a plurality of pixel rows so as to reduce the number of signal output sections, and therefore cost and size of a display device may be effectively reduced.

FIG. 17 shows a schematic configuration of a display device, in which each signal output section in a power line driver circuit is shared by a plurality of pixel rows. In a display device 100 of FIG. 17, power lines PSL (PSL1, PSL2, . . . ) are individually connected to each signal output section in a power line driver circuit 140, and pixels 111 in a plurality of pixel rows (three rows in FIG. 17) are connected to each of the power lines PSL (PSL1, PSL2, . . . ). Signal lines DTL (DTL1, DTL2, . . . ) are individually connected to each of signal output sections in a signal line driver circuit 120, and one pixel 111 in each row is individually connected to each of the signal lines DTL (DTL1, DTL2, . . . ). Write lines WSL (WSL1, WSL2, . . . ) are individually connected to each signal output section in a write line driver circuit 130, and one pixel 111 in each row is individually connected to each of the write lines WSL (WSL1, WSL2, . . . ).

FIG. 18 shows an example of various waveforms in the display device 100 of FIG. 17. FIG. 18 shows an aspect where two kinds of voltages (V_{cc} and Vₛₛ) are applied to the power lines PSL, and two kinds of voltages (Vₒₙ and V_{off}) are applied to the write lines WSL1 to WSL6. As understood from FIG. 18, unit scan is performed in the display device 100, where V_{cc} or Vₛₛ are applied at a common timing from each of the power lines PSL (PSL1, PSL2, . . . ) to pixels 111 in each of units with a plurality of pixel rows (three rows in FIG. 18) as a unit.

As shown in FIG. 18, time (waiting time) from time T₁ when voltage of a power line PSL rises from Vₛₛ to V_{cc} to time T₂ when threshold correction is started is different for each of lines in one unit. For example, when one unit has 30 lines, a difference in waiting time between a first line and a 30th line is 29H. Since current leakage occurs in a pixel circuit during the waiting time, source voltage of a driver transistor rises with increase in waiting time. Therefore, in one unit, gate-to-source voltage of a pixel 111 in a final line becomes small compared with gate-to-source voltage of a pixel 111 in a first line. As a result, when the number of lines in one unit is excessively large, luminance of the final line is decreased from luminance of the first line in a period from the time T₁ to the time T₂, resulting in occurrence of a stripe pattern between adjacent units.

In addition, as shown in FIG. 18, time (waiting time) from time T₃ when non-emission operation is started to time T₄ when voltage of a power line PSL lowers from V_{cc} to Vₛₛ is different for each of lines in one unit. For example, when one unit has 30 lines, a difference in waiting time between a first line and a 30th line is 29H. Source voltage gradually lowers during the waiting time, which slowly proceeds due to capacitance of an organic EL element 111R and the like, therefore a slight current flows in the pixel circuit during the period from the time T₃ to the time T₄. As a result, when one unit has an excessively large number of lines, luminance of the first line is increased from luminance of the final line in the period from the time T₃ to the time T₄, and consequently a stripe pattern occurs between adjacent units.

In this way, the related art has had a difficulty where a stripe pattern occurs between adjacent units due to difference in waiting time for each of lines.

It is desirable to provide a display device, in which occurrence of a stripe pattern may be prevented in unit scan, a method of driving the display device, and an electronic unit having the display device.

A display device according to an embodiment of the invention has a display section including a plurality of scan lines and a plurality of power lines, being arranged in rows, a plurality of signal lines arranged in columns, and a plurality of pixels arranged in a matrix, and further has a driver section driving each pixel. The power lines are individually provided for each of units with a plurality of pixel rows as a unit. The driver section reverses a scan direction of scan lines in the unit between odd and even fields.

An electronic unit according to an embodiment of the invention includes the display device.

A method of driving a display device according to an embodiment of the invention performs a step of reversing a scan direction of scan lines in a unit between odd and even fields in a display device having the following configuration.

The display device applied with the above method has a display section including a plurality of scan lines and a plurality of power lines, being arranged in rows, a plurality of signal lines arranged in columns, and a plurality of pixels arranged in a matrix, and further has a driver section driving each pixel. The power lines are individually provided for each of units with a plurality of pixel rows as a unit.

In the display device, the method of driving the display device, and the electronic unit according to the embodiments of the invention, a scan direction of scan lines in a unit is reversed between odd and even fields. Thus, gradation in the odd field and gradation in the even field are canceled by each other, leading to uniform luminance distribution in a column direction.

According to the display device, the method of driving the display device, and the electronic unit of the embodiments of the invention, gradation in the odd field and gradation in the even field are canceled by each other, leading to uniform luminance distribution in a column direction. This may prevent occurrence of a stripe pattern between adjacent units in unit scan.

Other and further objects, features and advantages of the invention will appear more fully from the following description.

### BRIEF DESCRIPTION OF THE DRAWINGS

FIG. 1 is a block diagram showing an example of a display device according to an embodiment of the invention.

FIG. 2 is a block diagram showing an example of an internal configuration of a pixel in FIG. 1.

FIG. 3 is a conceptual diagram for illustrating an aspect of unit scan in the display device of FIG. 1.

FIG. 4 is a waveform diagram for illustrating an example of operation of the display device of FIG. 1.

FIG. 5 is a waveform diagram for illustrating an example of operation of one display pixel.

FIG. 6 is a waveform diagram for illustrating another example of operation of the display device of FIG. 1.

FIGS. 7A to 7C are schematic diagrams for illustrating an example of gradation (luminance distribution) in each of odd and even fields.

FIG. 8 is a waveform diagram for illustrating still another example of operation of the display device of FIG. 1.

FIG. 9 is a waveform diagram for illustrating still another example of operation of the display device of FIG. 1.

FIGS. 10A to 10C are schematic diagrams for illustrating another example of gradation (luminance distribution) in each of odd and even fields.

FIG. 11 is a plan diagram showing a schematic configuration of a module including the display device of the embodiment.

FIG. 12 is a perspective diagram showing appearance of application example 1 of the display device of the embodiment.

FIGS. 13A and 13B are perspective diagrams, where FIG. 13A shows appearance of application example 2 as viewed from a surface side, and FIG. 13B shows appearance thereof as viewed from a back side.

FIG. 14 is a perspective diagram showing appearance of application example 3.

FIG. 15 is a perspective diagram showing appearance of application example 4.

FIGS. 16A to 16G are diagrams of application example 5, where FIG. 16A is a front diagram of the application example 5 in an opened state, FIG. 16B is a side diagram thereof, FIG. 16C is a front diagram thereof in a closed state, FIG. 16D is a left side diagram thereof, FIG. 16E is a right side diagram thereof, FIG. 16F is a top diagram thereof, and FIG. 16G is a bottom diagram thereof.

FIG. 17 is a block diagram showing an example of a display device of the related art.

FIG. 18 is a waveform diagram for illustrating an example of operation of the display device of FIG. 17.

FIG. 19 is a circuit diagram for illustrating current leakage in the display device of FIG. 17.

### DETAILED DESCRIPTION OF THE PREFERRED EMBODIMENTS

Hereinafter, a preferred embodiment of the invention will be described in detail with reference to drawings. Description is made in the following sequence.

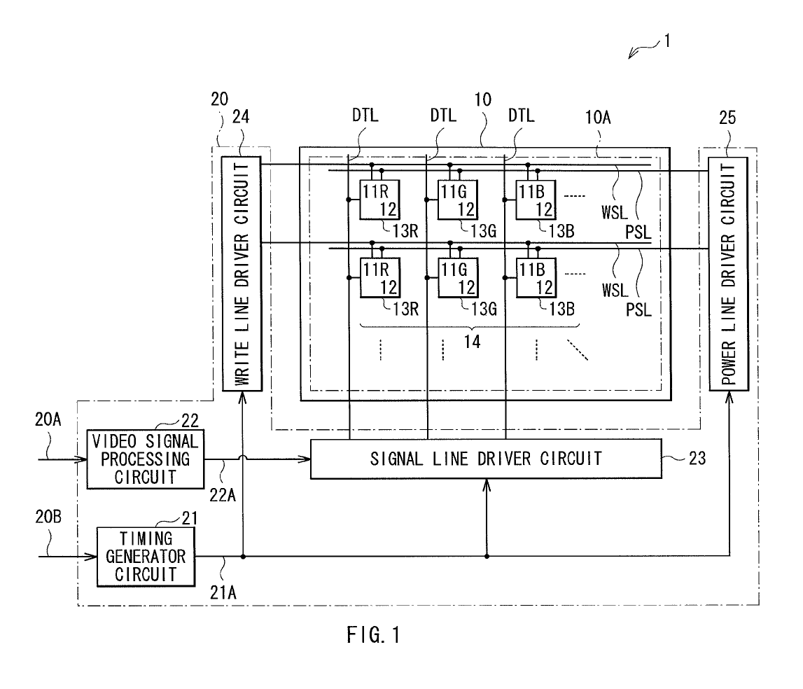

1. Embodiment (FIGS. 1 to 7C)

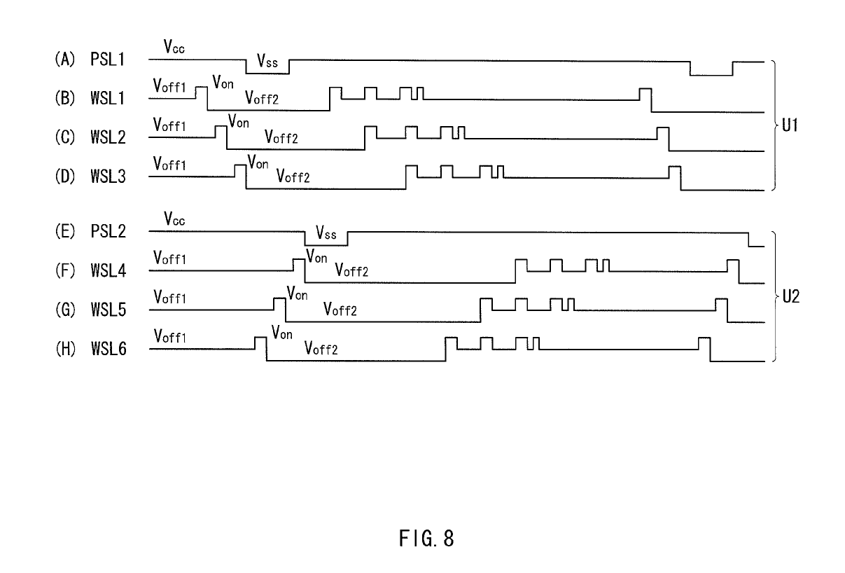

2. Modifications (FIGS. 8 to 10C)

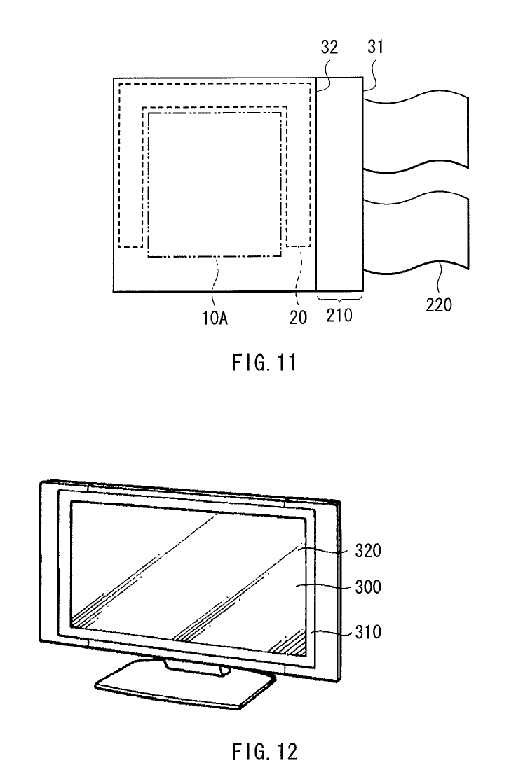

3. Module and application examples (FIGS. 11 to 16G)

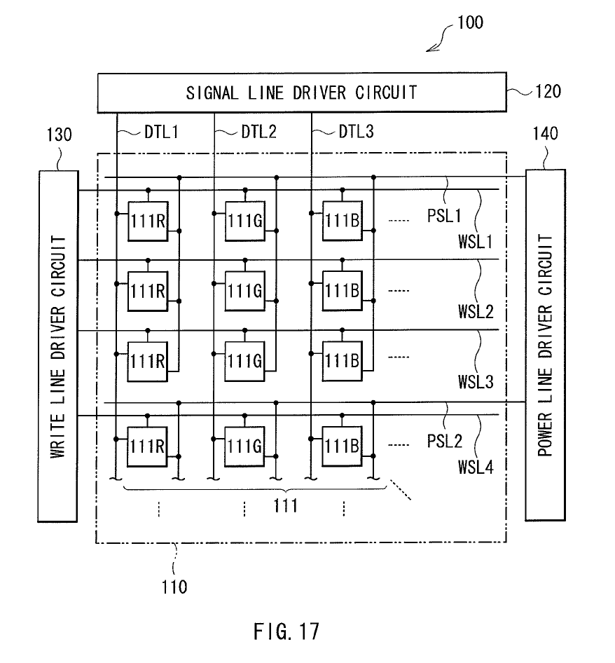

4. Example of the related art (FIGS. 17 to 19)

FIG. 1 shows an example of a general configuration of a display device 1 according to an embodiment of the invention. The display device 1 has, for example, a display panel 10 (display section) and a driver circuit 20 (driver section).

Display Panel 10

The display panel 10 has a display region 10A, in which three kinds of organic EL elements 11R, 11G and 11B (light emitting elements) having different emission colors from one another, are two-dimensionally arranged. The display region 10A is a region for displaying video pictures by using light emitted from the organic EL elements 11R, 11G and 11B. The organic EL element 11R emits red light, the organic EL element 11G emits green light, and the organic EL element 11B emits blue light. Hereinafter, a term, organic EL element 11, is appropriately used as a general term of the organic EL elements 11R, 11G and 11B.

Display Region 10A

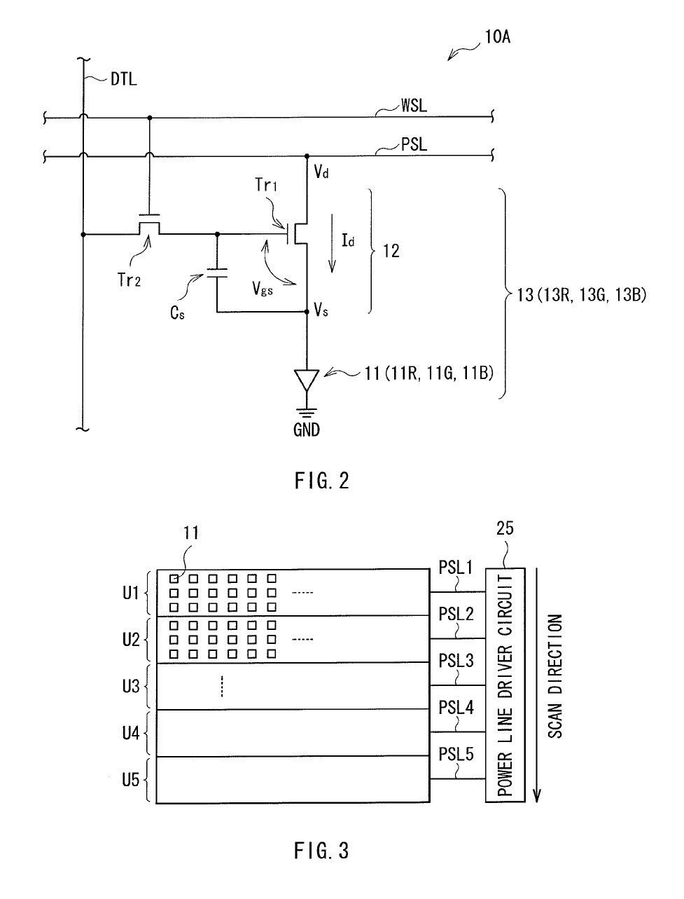

FIG. 2 shows an example of a configuration of a circuit in the display region 10A. In the display region 10A, a plurality of pixel circuits 12 individually coupled with organic EL elements 11 are two-dimensionally arranged. In the embodiment, an organic EL element 11 is coupled with a pixel circuit 12 to configure one pixel 13. Specifically, as shown in FIG. 1, an organic EL element 11R is coupled with a pixel circuit 12 to configure one pixel 13R (red pixel), an organic EL element 11G is coupled with a pixel circuit 12 to configure one pixel 13G (green pixel), and an organic EL element 11B is coupled with a pixel circuit 12 to configure one pixel 13B (blue pixel). Furthermore, three pixels 13R, 13G and 13B adjacent to one another configure one display pixel 14.

Each pixel circuit 12 is configured of, for example, a driver transistor Tr₁ (first transistor) controlling a current flowing into the organic EL element 11, a write transistor Tr₂ (second transistor) writing voltage of a signal line DTL into the driver transistor Tr₁, and a capacitance Cₛ, namely, the pixel circuit has a circuit configuration of 2Tr1C. The driver transistor Tr₁ and the write transistor Tr₂ are, for example, formed of an n-channel MOS thin-film transistor (TFT) each. The driver transistor Tr₁ or the write transistor Tr₂ may be, for example, a p-channel MOS TFT.

In the display region 10A, a plurality of write lines WSL (scan lines) are arranged in rows, and a plurality of signal lines DTL are arranged in columns. Furthermore, a plurality of power lines PSL (members supplied with source voltage) are arranged in rows along the write lines WSL in the display region 10A. The organic EL elements 11 are individually provided near intersections between the signal lines DTL and the scan lines WSL. Each signal line DTL is connected to an output end (not shown) of a signal line driver circuit 23 described later and one of drain and source electrodes (not shown) of the write transistor Tr₂. Each scan line WSL is connected to an output end (not shown) of a write line driver circuit 24 described later and a gate electrode (not shown) of the write transistor Tr₂. Each power line PSL is connected to an output end (not shown) of a power line driver circuit 25 described later and one of drain and source electrodes (not shown) of the driver transistor Tr₁. The other of the drain and source electrodes (not shown), being not connected to the signal line DTL, of the write transistor Tr₂ is connected to a gate electrode (not shown) of the driver transistor Tr₁ and one end of the capacitance Cₛ. The other of the drain and source electrodes (not shown), being not connected to the power line PSL, of the driver transistor Tr₁ and the other end of the capacitance Cₛ are connected to an anode electrode (not shown) of the organic EL element 11. A cathode electrode (not shown) of the organic EL element 11 is connected to, for example, a ground line GND.

As shown in FIGS. 1 and 3, the power lines PSL are individually provided for each of units U with a plurality of pixel rows as one unit U. While FIG. 3 illustrates a case where five units U are provided, the number of units is not limited to five. In FIG. 3, five units U are attached with suffixes increasing one by one in a scan direction of the power line driver circuit 25. Therefore, unit U1 corresponds to a first unit in the scan direction, and unit U5 corresponds to a final unit in the scan direction.

Driver Circuit 20

Next, circuits in the driver circuit 20 are described with reference to FIG. 1. The driver circuit 20 has a timing generator circuit 21, a video signal processing circuit 22, the signal line driver circuit 23, the write line driver circuit 24, and the power line driver circuit 25.

The timing generator circuit 21 controls the video signal processing circuit 22, the signal line driver circuit 23, the write line driver circuit 24, and the power line driver circuit 25 such that the circuits operate in conjunction with one another. For example, the timing generator circuit 21 outputs a control signal 21A to each of the circuits in response to (in synchronization with) a synchronizing signal 20B received from the outside.

The video signal processing circuit 22 applies predetermined correction to a video signal 20A received from the outside, and outputs a corrected video signal 22A to the signal line driver circuit 23. Such predetermined correction includes, for example, gamma correction and overdrive correction.

The signal line driver circuit 23 applies the video signal 22A (signal voltage V_{sig}) received from the video signal processing circuit 22 to each signal line DTL in response to (in synchronization with) input of the control signal 21A to perform writing of the video signal into a pixel 13 as a selection target. Writing means application of a predetermined voltage to the gate of the driver transistor Tr₁.

The signal line driver circuit 23 is, for example, configured of a shift resistor (not shown), which has a signal output section (not shown) for each stage in correspondence to each column of the pixels 13. The signal line driver circuit 23 may output three kinds of voltages (V_{sig}, V_{ofs} and Vₑᵣₛ) to each signal line DTL in response to (in synchronization with) input of the control signal 21A. Specifically, the signal line driver circuit 23 sequentially supplies the three kinds of voltages (V_{sig}, V_{ofs} and Vₑᵣₛ) to a pixel 13 selected by the write line driver circuit 24 via a signal line DTL connected to each pixel 13.

Here, V_{sig} has a value corresponding to the video signal 22A. A lowest voltage of V_{sig} has a value lower than V_{ofs}, and a highest voltage of V_{sig} has a value higher than V_{ofs}. V_{ofs} is a non-gray-scale signal independent of the video signal 22A, and has a value (fixed value) lower than Vₑᵣₛ. Vₑᵣₛ has a value (fixed value) lower than a threshold voltage Vₑₗ of the organic EL element 11.

The write line driver circuit 24 is, for example, configured of a shift resistor (not shown), and has a signal output section (not shown) for each stage in correspondence to each row of the pixels 13. The write line driver circuit 24 may output three kinds of voltages (Vₒₙ, V_{off1} and V_{off2}) to each write line WSL in response to (in synchronization with) input of the control signal 21A. Specifically, the write line driver circuit 24 supplies the three kinds of voltages (Vₒₙ, V_{off1} and V_{off2}) to a pixel 13 as a driving target via a write line WSL connected to each pixel 13 so as to control the write transistor Tr₂.

Here, the voltage Vₒₙ has a value higher than a value of ON voltage of the write transistor Tr₂. Vₒₙ is a voltage output from the write line driver circuit 24 when non-emission operation or threshold correction described later is performed. Each of V_{off1} and V_{off2} has a value lower than a value of ON voltage of the write transistor Tr₂. V_{off2} has a value lower than a value of V_{off1}.

The power line driver circuit 25 is, for example, configured of a shift resistor (not shown), and has signal output sections (not shown) for stages, being the same in number as rows in each of units (U1 to U5), for each of the units (U1 to U5). In other words, in the embodiment, each output stage of the shift register in the power line driver circuit 25 is shared for each of the units (U1 to U5), namely, unit scan is performed. Therefore, the number of signal output sections in the power line driver circuit 25 is small compared with a case where a signal output section is provided for each stage in correspondence to each pixel column.

The power line driver circuit 25 may output two kinds of voltages (Vₛₛ and V_{cc}) in response to (in synchronization with) input of the control signal 21A. Specifically, the power line driver circuit 25 supplies the two kinds of voltages (Vₛₛ and V_{cc}) to a pixel 13 as a driving target via a power line PSL connected to each pixel 13 so as to control emission operation and non emission operation of the organic EL element 11.

Here, Vₛₛ has a value lower than a value of voltage (Vₑₗ+V_{ca}) as the sum of the threshold voltage Vₑₗ of the organic EL element 11 and a cathode voltage V_{ca} thereof. V_{cc} has a value equal to or higher than the value of the voltage (Vₑₗ+V_{ca}).

Next, an example of operation (operation from emission stop to emission start) of the display device 1 of the embodiment is described. In the embodiment, the display device has a function of correcting variation in threshold voltage Vₜₕ or mobility μ of the driver transistor Tr₁ so that even if the threshold voltage Vₜₕ or the mobility μ is temporally changed, luminance of the organic EL element 11 is not affected by such change, and is thus kept constant.

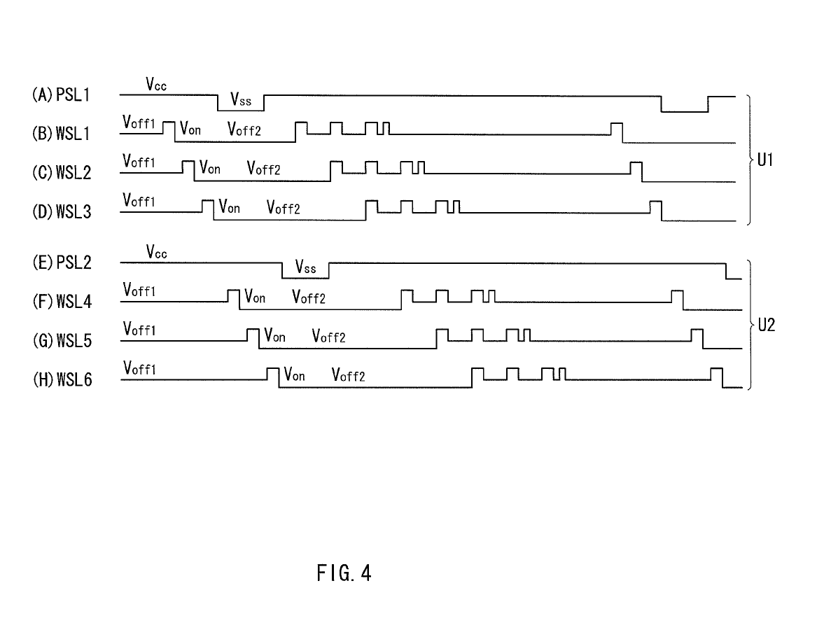

FIG. 4 shows an example of various waveforms in the display device 1. FIG. 4 shows an aspect where two kinds of voltages (Vₛₛ and V_{cc}) are applied to power lines PSL, and three kinds of voltages (Vₒₙ, V_{off1} and V_{off2}) are applied to write lines WSL1 to WSL6. As understood from FIGS. 1 and 4, in the display device 1, Vₛₛ and V_{cc} are applied from power lines PSL (PSL1, PSL2, . . . ) to pixels 13 for each of units (U1 to U5) at a common timing.

FIG. 5 shows an example of voltage waveforms applied to one unit U of the display device 1. Specifically, FIG. 5 shows an aspect where two kinds of voltages (Vₛₛ and V_{cc}) are applied to a power line PSL, three kinds of voltages (V_{sig}, Vₑᵣₛ and V_{ofs}) are applied to a signal line DTL, and three kinds of voltages (Vₒₙ, V_{off1} and V_{off2}) are applied to write lines WSL. Furthermore, FIG. 5 shows an aspect where gate voltage V_{g} and source voltage Vₛ of the driver transistor Tr₁ change every moment in correspondence to voltage application to a power line PSL1, the signal line DTL, and a write line WSL1.

Non-Emission Period

First, light emission of the organic EL element 11 is stopped. Specifically, when voltage of the power line PSL is V_{cc}, and voltage of the signal line DTL is Vₑᵣₛ, the write line driver circuit 24 raises voltage of the write line WSL from V_{off1} to Vₒₙ (T₁), so that the gate of the driver transistor Tr₁ is connected to the signal line DTL. Thus, the gate voltage V_{g} of the driver transistor Tr₁ begins to lower, and the source voltage Vₛ of the driver transistor Tr₁ also begins to lower through coupling via the capacitance Cₛ. Then, when the gate voltage V_{g} reaches Vₑᵣₛ, and the source voltage Vₛ reaches Vₑₗ+V_{ca} (V_{ca} is cathode voltage of the organic EL element 11), and light emission of the organic EL element 11 is thus stopped, the write line driver circuit 24 lowers voltage of the write line WSL from Vₒₙ to V_{off1} so that the gate of the driver transistor Tr₁ becomes floating (T₂).

Threshold Correction Preparation Period

Next, preparation of threshold correction is performed. Specifically, when voltage of the write line WSL is V_{off2}, the power line driver circuit 25 lowers voltage of the power line PSL from V_{cc} to Vₛₛ (T₃). Thus, a power line PSL side of the driver transistor Tr₁ turns into a source, so that current I_{d} flows between the drain and the source of the driver transistor Tr₁, and when the gate voltage V_{g} reaches Vₛₛ+Vₜₕ, the current I_{d} stops flowing. At that time, the source voltage Vₛ is Vₑₗ+V_{ca}−(Vₑᵣₛ−(Vₛₛ+Vₜₕ)), and potential difference V_{gs} is lower than Vₜₕ.

Next, the power line driver circuit 25 raises voltage of the power line PSL from Vₛₛ to V_{cc} (T₄). Thus, current I_{d} flows between the drain and the source of the driver transistor Tr₁, and the gate voltage V_{g} and the source voltage Vₛ rise due to capacitive coupling between gate-to-drain parasitic capacitance of the driver transistor Tr₁ and the capacitance Cₛ. At that time, potential difference V_{gs} is still lower than Vₜₕ.

First Threshold Correction Period

Next, threshold correction is performed. Specifically, when voltage of the power line PSL is V_{cc}, and voltage of the signal line DTL is V_{ofs} (threshold correction signal having a fixed crest value), the write line driver circuit 24 raises voltages of the write lines WSL from V_{off2} to Vₒₙ so that a selection pulse is applied to each write line WSL (T₅). Thus, current I_{d} flows between the drain and the source of the driver transistor Tr₁, and the gate voltage V_{g} and the source voltage Vₛ rise due to capacitive coupling between gate-to-drain parasitic capacitance of the driver transistor Tr₁ and the capacitance Cₛ. Since the capacitance Cₛ is extremely small compared with element capacitance of the organic EL element 11, and increase amount in source voltage Vₛ is thus sufficiently small compared with increase amount in gate voltage V_{g}, potential difference V_{gs} becomes large. When potential difference V_{gs} becomes larger than Vₜₕ, the write line driver circuit 24 lowers voltages of the write lines WSL from Vₒₙ to V_{off1} (T₆). Thus, the gate of the driver transistor Tr₁ becomes floating, and threshold correction is thus suspended.

First Threshold Correction Suspension Period

During suspension of threshold correction, for example, sampling of voltage of the signal line DTL is performed in a row (pixel) different from a row (pixel) subjected to the previous threshold correction. At that time, the source voltage Vₛ is lower than V_{ofs}−Vₜₕ in the row (pixel) subjected to the previous threshold correction. Therefore, in the row (pixel) subjected to the previous threshold correction, current I_{d} flows between the drain and the source of the driver transistor Tr₁, and thus the source voltage Vₛ rises, and the gate voltage V_{g} also rises through coupling via the capacitance Cₛ even during the threshold correction suspension period.

Second Threshold Correction Period

When the threshold correction suspension period has been finished, threshold correction is performed again. Specifically, when voltage of the signal line DTL is V_{ofs}, and threshold correction is thus enabled, the write line driver circuit 24 raises voltages of the write lines WSL from V_{off1} to Vₒₙ (T₅), so that the gate of the driver transistor Tr₁ is connected to the signal line DTL. At that time, when the source voltage Vₛ is lower than V_{ofs}-Vₜₕ (threshold correction is not completed yet), current I_{d} flows between the drain and the source of the driver transistor Tr₁ until the driver transistor Tr₁ is cut off (until the potential difference V_{gs} reaches Vₜₕ). Then, the write line driver circuit 24 lowers voltages of the write lines WSL from Vₒₙ to V_{off1}, and then the signal line driver circuit 23 changes voltage of the signal line DTL from V_{ofs} to V_{sig} (T₆). Thus, since the gate of the driver transistor Tr₁ becomes floating, the potential difference V_{gs} may be kept constant regardless of magnitude of voltage of the signal line DTL.

In the threshold correction period, when the capacitance Cₛ is charged to Vₜₕ, and the potential difference V_{gs} reaches Vₜₕ, threshold correction is finished. When the potential difference V_{gs} does not reach Vₜₕ in the period, threshold correction and threshold correction suspension are repeatedly performed until the potential difference V_{gs} reaches Vₜₕ.

Writing and μ-Correction Period

When the threshold correction suspension period has been finished, writing and p-correction are performed. Specifically, when voltage of the signal line DTL is V_{sig}, the write line driver circuit 24 raises voltages of the write lines WSL from V_{off1} to Vₒₙ (T₇), so that the gate of the driver transistor Tr₁ is connected to the signal line DTL. Thus, gate voltage of the driver transistor Tr₁ becomes V_{sig}. In this stage, anode voltage of the organic EL element 11 is still lower than the threshold voltage Vₑₗ of the element 11, and therefore the organic EL element 11 is cut off. Therefore, current I_{d} flows into element capacitance of the organic EL element 11, so that the element capacitance is charged, resulting in increase in source voltage Vₛ by ΔV, and eventually potential difference V_{gs} becomes V_{sig}+Vₜₕ−ΔV. In this way, writing and p-correction are concurrently performed.

Light Emission

Finally, the write line driver circuit 24 lowers voltages of the write lines WSL from Vₒₙ to V_{off} (T₈). Thus, the gate of the driver transistor Tr₁ becomes floating, so that current I_{d} flows between the drain and the source of the driver transistor Tr₁ and thus the source voltage Vₛ rises. As a result, the organic EL element 11 emits light with a desired luminance.

Field Inversion Drive

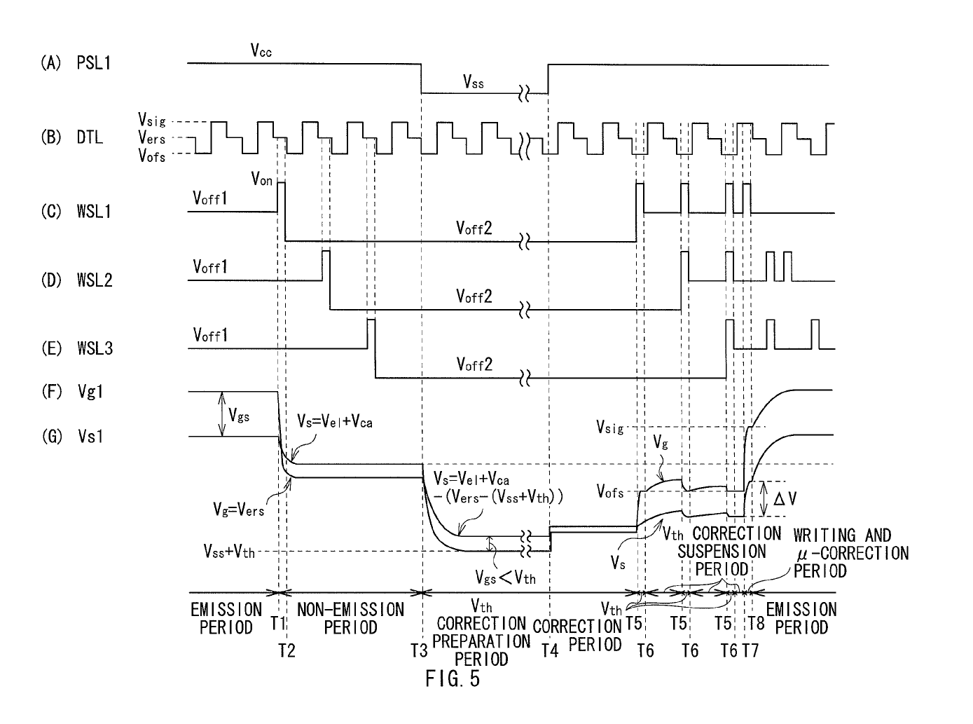

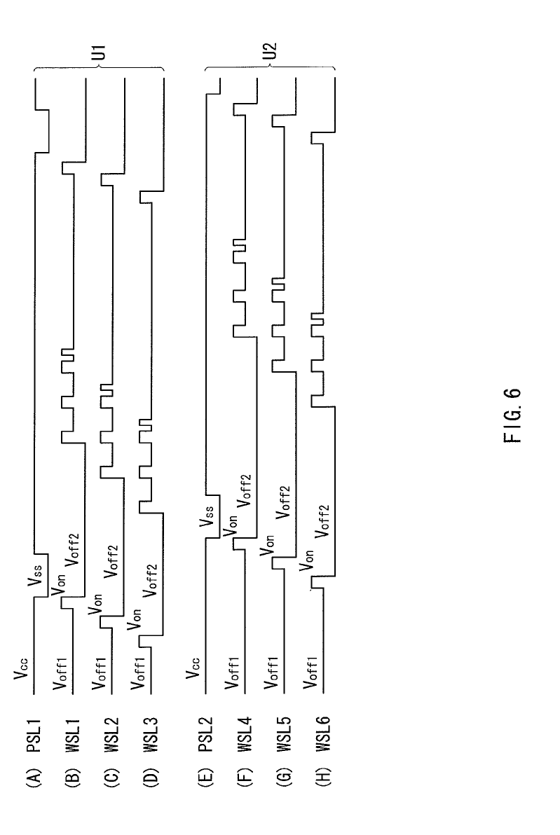

The write line driver circuit 24 performs field inversion drive where a scan direction of scan lines WSL in a unit U is reversed between odd and even fields. The write line driver circuit 24 scans scan lines in the same direction as a scan direction of the units U (scan direction of the power line driver circuit 25) in the odd field, for example, as shown in FIGS. 4B to 4D, and scans the scan lines in a direction opposite to the scan direction of the units U (scan direction of the power line driver circuit 25) in the even field, for example, as shown in FIGS. 6B to 6D.

In the display device 1 of the embodiment, the pixel circuit 12 of each pixel 13 is subjected to ON/OFF control and thus drive current is injected into the organic EL element 11 of each pixel 13 as in the above way, and therefore holes and electrons are recombined, causing light emission, and the light is extracted to the outside. As a result, images are displayed in the display region 10A of the display panel 10.

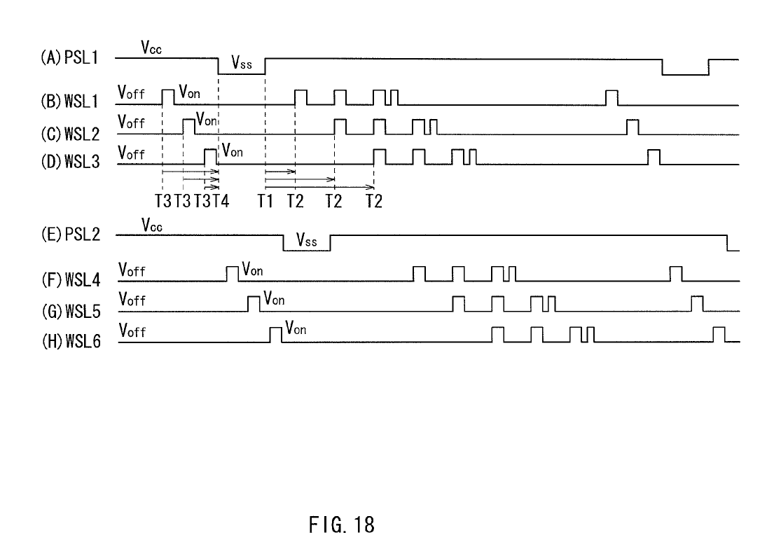

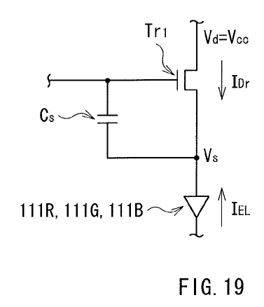

In the unit scan in the display device 100 of the related art as shown in FIG. 17, time (waiting time) from time T₁ when voltage of the power line PSL rises from Vₛₛ to V_{cc} to time T₂ when threshold correction is started is different for each of lines in one unit, for example, as shown in FIG. 18. For example, when one unit has 30 lines, a difference in waiting time between a first line and a 30th line is 29H. Since leakage current I_{Dr} through the driver transistor Tr₁ and leakage current I_{EL} through the organic EL element 11 occur during the waiting time, for example, as shown in FIG. 19, the source voltage Vₛ of the driver transistor Tr₁ rises with increase in waiting time. Therefore, in one unit, gate-to-source voltage (potential difference V_{gs}) of a pixel 111 in a final line becomes small compared with gate-to-source voltage (potential difference V_{gs}) of a pixel 111 in a first line. As a result, when one unit has an excessively large number of lines, luminance of the final line is decreased from luminance of the first line in a period from the time T₁ to the time T₂, resulting in occurrence of a stripe pattern between adjacent units.

In addition, as shown in FIG. 18, time (waiting time) from time T₃ when non-emission operation is started to time T₄ when voltage of the power line PSL lowers from V_{cc} to Vₛₛ is different for each of lines in one unit. For example, when one unit has 30 lines, a difference in waiting time between a first line and a 30th line is 29H. Source voltage Vₛ gradually lowers during the waiting time, which slowly proceeds due to capacitance of an organic EL element 111 and the like, therefore a slight current flows in a pixel circuit 112 during the period from the time T₃ to the time T₄. As a result, when one unit has an excessively large number of lines, luminance of the first line is increased from luminance of the final line in the period from the time T₃ to the time T₄, resulting in occurrence of a stripe pattern between adjacent units.

In this way, the previous method has a difficulty where a stripe pattern occurs between adjacent units due to difference in waiting time for each of lines.

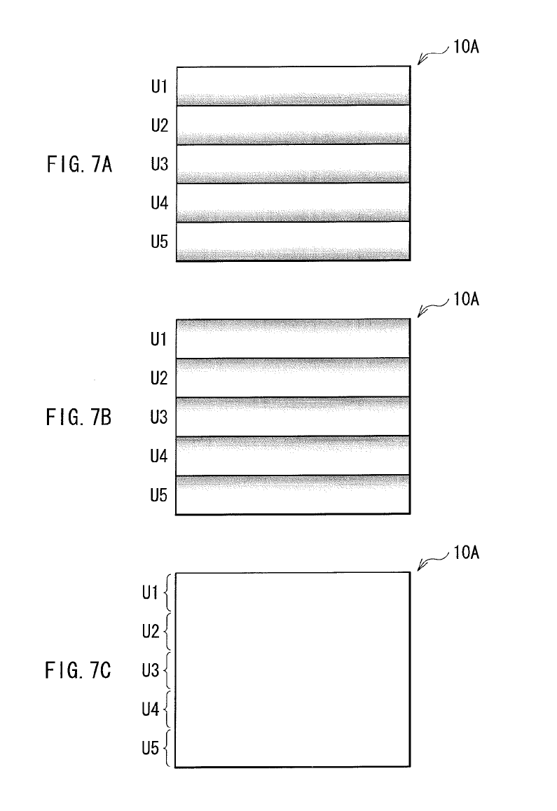

In the display device 1 of the embodiment, field inversion drive is performed, where a scan direction of write lines WSL in a unit U is reversed between odd and even fields. Thus, in the odd field, gradation is made such that luminance is highest in a first stage and gradually decreased in later stages in one unit U, for example, as shown in FIG. 7A. On the other hand, in the even field, gradation is made such that luminance is lowest in a first stage and gradually increased in later stages in one unit U, for example, as shown in FIG. 7B. In other words, opposite gradations are made between the odd and even fields. Therefore, light is alternately emitted between the odd and even fields, and therefore gradation in the odd field and gradation in the even field are canceled by each other, leading to uniform luminance distribution in a column direction, for example, as shown in FIG. 7C. Consequently, occurrence of a stripe pattern may be prevented in unit scan.

Modifications

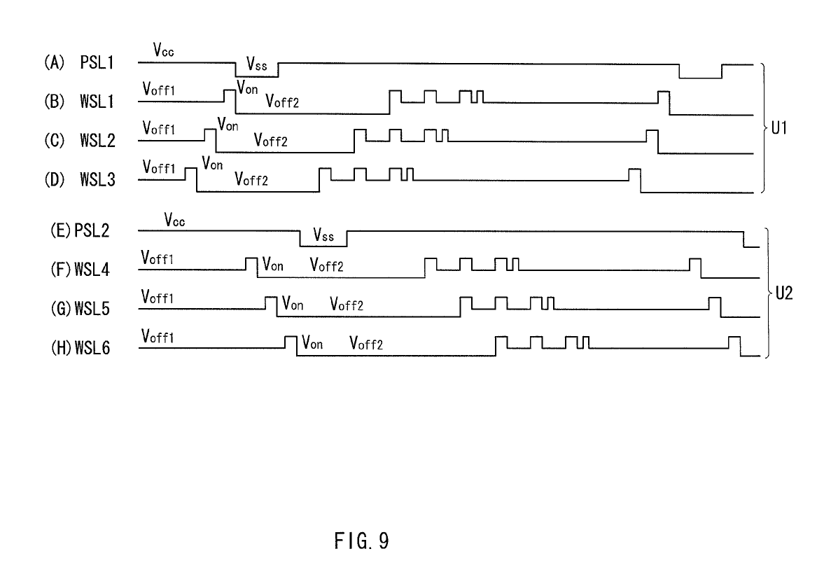

While field inversion drive, where a scan direction of write lines WSL in a unit U is reversed between odd and even fields, is performed in the embodiment, unit inversion drive may be performed, where units are further divided into odd units and even units, and a scan direction of write lines WSL in the odd units U is made opposite to a scan direction of write lines WSL in the even units U. For example, as shown in FIG. 8, the write line driver circuit 24 scans scan lines in the same direction as a scan direction of the units U (scan direction of the power line driver circuit 25) in the odd units in an odd field, and scans the scan lines in a direction opposite to the scan direction of the units U (scan direction of the power line driver circuit 25) in the even units in the odd field. Moreover, for example, as shown in FIG. 9, the write line driver circuit 24 scans scan lines in a direction opposite to a scan direction of units U (scan direction of the power line driver circuit 25) in the odd units in an even field, and scans the scan lines in the same direction as the scan direction of the units U (scan direction of the power line driver circuit 25) in the even units in the even field.

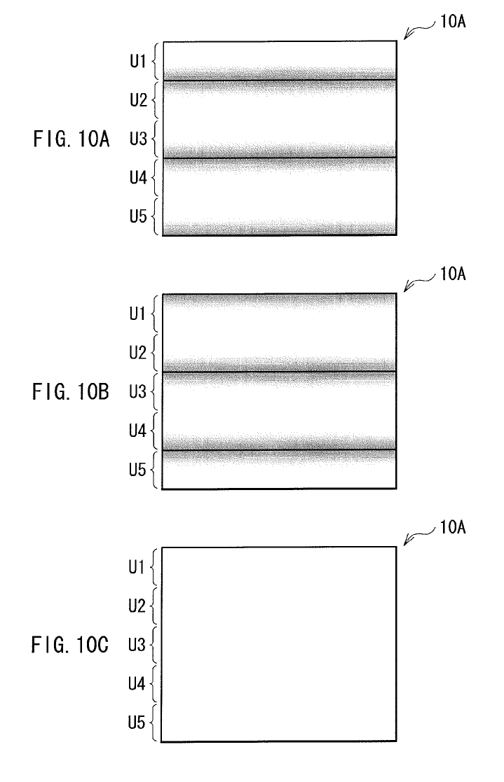

Thus, opposite gradations are made between the odd and even fields, for example, as shown in FIGS. 10A and 10B. Therefore, light is alternately emitted between the odd and even fields, and therefore gradation in the odd field and gradation in the even field are canceled by each other, leading to uniform luminance distribution in a column direction, for example, as shown in FIG. 10C. Consequently, occurrence of a stripe pattern may be prevented in unit scan.

Module and Application Examples

Next, application examples of the display device 1 described in the embodiment and the modifications are described. The display device 1 of the embodiment and the like may be applied to display devices of electronic units in any field for displaying still or video images based on an externally-input or internally-generated video signal, the electronic units including a television apparatus, a digital camera, a notebook personal computer, a mobile terminal such as mobile phone, and a video camera.

Module

The display device 1 of the embodiment and the like may be built in various electronic units such as application examples 1 to 5 described later, for example, in a form of a module shown in FIG. 11. In the module, for example, a region 210 exposed from a member (not shown) for sealing a display region 10A is provided in one side of a substrate 2, and external connection terminals (not shown) are formed in the exposed region 210 by extending wiring lines of a driver circuit 20. The external connection terminals may be attached with a flexible printed circuit (FPC) 220 for input or output of signals.

### Application Example 1

FIG. 12 shows appearance of a television apparatus using the display device 1 of the embodiment and the like. The television apparatus has, for example, an image display screen 300 including a front panel 310 and filter glass 320, and the image display screen 300 is configured of the display device 1 according to the embodiment and the like.

### Application Example 2

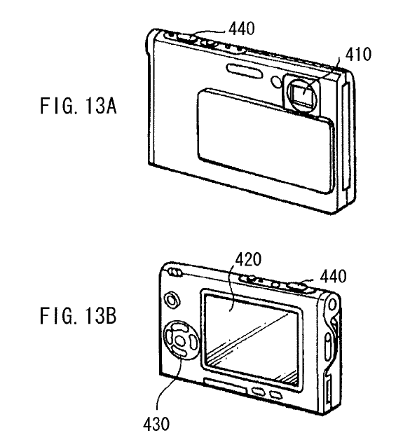

FIGS. 13A and 13B show appearance of a digital camera using the display device 1 of the embodiment and the like. The digital camera has, for example, a light emitting section for flash 410, a display 420, a menu switch 430 and a shutter button 440, and the display 420 is configured of the display device 1 according to the embodiment and the like.

### Application Example 3

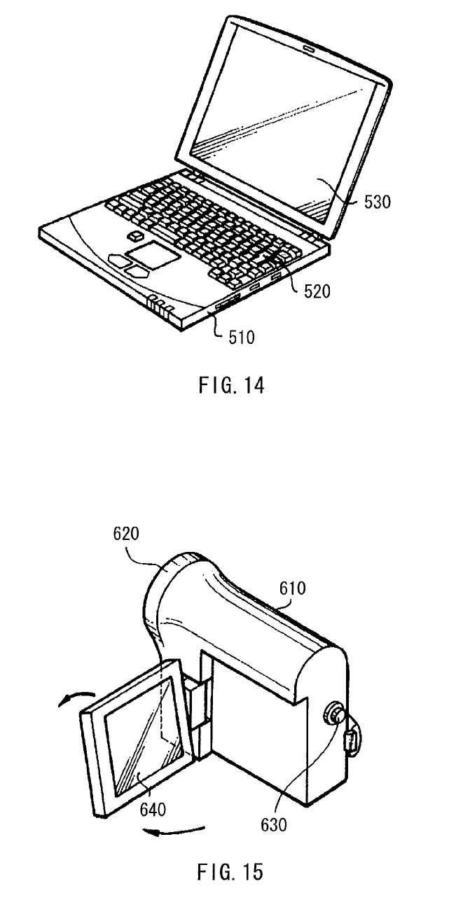

FIG. 14 shows appearance of a notebook personal computer using the display device 1 of the embodiment and the like. The notebook personal computer has, for example, a body 510, a keyboard 520 for input operation of letters and the like, and a display 530 for displaying images, and the display 530 is configured of the display device 1 according to the embodiment and the like.

### Application Example 4

FIG. 15 shows appearance of a video camera using the display device 1 of the embodiment and the like. The video camera has, for example, a body 610, an object-shooting lens 620 provided on a front side-face of the body 610, a start/stop switch 630 for shooting, and a display 640. The display 640 is configured of the display device 1 according to the embodiment and the like.

### Application Example 5

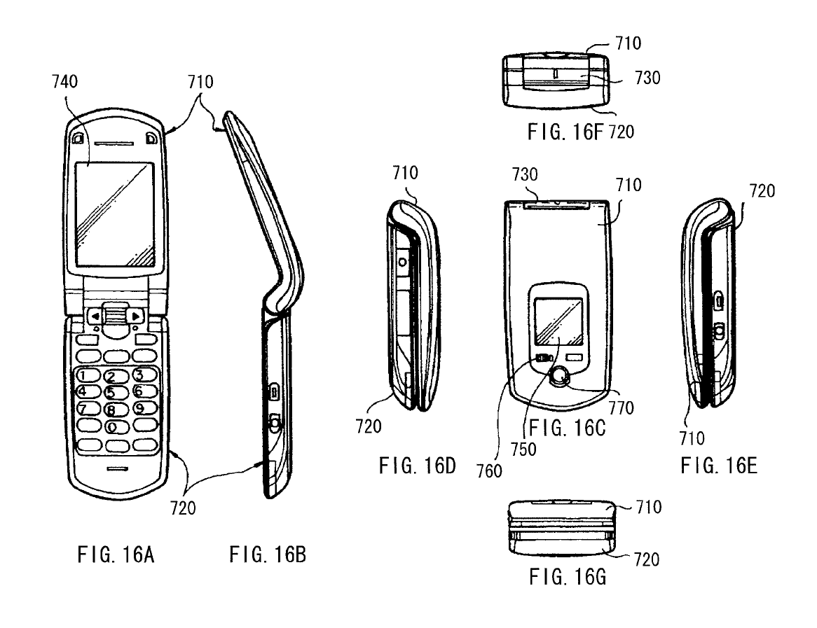

FIGS. 16A to 16G show appearance of a mobile phone using the display device 1 of the embodiment and the like. For example, the mobile phone is assembled by connecting an upper housing 710 to a lower housing 720 by a hinge 730, and has a display 740, a sub display 750, a picture light 760, and a camera 770. The display 740 or the sub display 750 is configured of the display device 1 according to the embodiment and the like.

While the invention has been described with the embodiment and the application examples hereinbefore, the invention is not limited to the embodiment and the like, and various modifications and alterations may be made.

For example, while the embodiment and the like have been described with a case where the display device 1 is an active-matrix display device, a configuration of the pixel circuit 12 for active matrix drive is not limited to those described in the embodiment and the like, and a capacitive element or a transistor may be added to the pixel circuit 12 as necessary. In such a case, a driver circuit to be necessary may be added in addition to the signal line driver circuit 23, the write line driver circuit 24, and the power line driver circuit 25 in correspondence to change in pixel circuit 12.

Moreover, while the timing generator circuit 21 controls drive of each of the signal line driver circuit 23, the write line driver circuit 24, and the power line driver circuit 25 in the embodiment and the like, another circuit may control drive of the circuits. In addition, the signal line driver circuit 23, the write line driver circuit 24, and the power line driver circuit 25 may be controlled by hardware (circuit) or software (program).

Moreover, while the pixel circuit 12 has a circuit configuration of 2Tr1C in the embodiment and the like, the circuit 12 may have any circuit configuration other than 2Tr1C as long as the circuit configuration includes a dual-gate transistor connected in series to the organic EL element 11.

Moreover, while a case where the driver transistor Tr₁ and the write transistor Tr₂ are formed of n-channel MOS thin film transistors (TFT) has been exemplified in the embodiment and the like, the transistors may be formed of p-channel transistors (for example, p-channel MOS TFT). In such a case, preferably, one of the source and drain of the transistor Tr₂, being not connected to the power line PSL, and the other end of the capacitance Cₛ are connected to the cathode of the organic EL element 11, and the anode of the organic EL element 11 is connected to GND.

The present application contains subject matter related to that disclosed in Japanese Priority Patent Application JP 2010-006990 filed in the Japan Patent Office on Jan. 15, 2010, the entire content of which is hereby incorporated by reference.

It should be understood by those skilled in the art that various modifications, combinations, sub-combinations and alterations may occur depending on design requirements and other factors insofar as they are within the scope of the appended claims or the equivalent thereof.

What is claimed is:

1. A display device comprising:
a display section including a plurality of scan lines and a plurality of power lines, being arranged in rows, a plurality of signal lines arranged in columns, and a plurality of pixels arranged in a matrix; and
a driver section driving each pixel,
wherein the power lines are individually provided for each of units with a plurality of pixel rows as a unit, and
the driver section reverses a scan direction of scan lines in the unit between odd and even fields.

2. The display device according to claim 1,
wherein the driver section further divides the plurality of units into odd units and even units, and makes a scan direction of scan lines in the odd units to be opposite to a scan direction of scan lines in the even units.

3. A method of driving a display device,
the display device having a display section including a plurality of scan lines and a plurality of power lines, being arranged in rows, a plurality of signal lines arranged in columns, and a plurality of pixels arranged in a matrix,
the power lines being individually provided for each of units with a plurality of pixel rows as a unit:
wherein a scan direction of scan lines in the unit is reversed between odd and even fields.

4. An electronic unit including a display device, the display device comprising:
a display section including a plurality of scan lines and a plurality of power lines, being arranged in rows, a plurality of signal lines arranged in columns, and a plurality of pixels arranged in a matrix; and
a driver section driving each pixel,
wherein the power lines are individually provided for each of units with a plurality of pixel rows as a unit, and
the driver section reverses a scan direction of scan lines in the unit between odd and even fields.
